(19) United States
(12) Patent Application Publication
(10) Pub. No.: US 2012/0113666 A1
(43) Pub. Date: May 10, 2012

(54) Dual light bar assembly

(75) Inventor: Donald Slipp, Waretown, NJ (US)

(73) Assignee: Proline U.S.

(21) Appl. No.: 12/927,222

(22) Filed: Nov. 9, 2010

(51) Int. Cl. F21V 21/14

(52) U.S. Cl. 362/523

(57) ABSTRACT

A dual light bar assembly is provided with a base member or first light bar with a cavity inset within the light bar, between its end sections. A smaller, light bar insert panel is configured to be housed within the cavity when only the first light bar is being used. Scissor linkage between the first light bar and the light bar insert panel serves to raise and lower the insert panel from a position within the first light bar to an elevated position over the first light bar, which, as a result of the elevation of the insert panel, provides visual illumination and enhanced visibility at great distances from the vehicle on which the light bar assembly is mounted.

### BACKGROUND OF THE INVENTION

Light bars are routinely mounted on the roofs of police cars, ambulances, and fire fighting and other emergency vehicles. These light bars provide visual indication of the presence of the vehicle on the scene of an accident, fire, investigation, or other significant activity. However, despite the bright and flashing lights which are utilized in light bars, the relative low heights of the vehicles on which they are mounted, even of police and other emergency vans, limit the distance at which the lights can be seen.

There have been attempts to elevate emergency and warning lights over vehicles, with limited success. Prior vehicle mounted elevated light systems have been impractical because they comprise numerous complex parts, which make them susceptible to failing or breaking down. Most existing systems are cumbersome and difficult to mount on vehicle roofs. Others lack the necessary stability to permit the lighting to be maintained rigidly on the vehicle, in all wind and weather conditions. Significantly, no prior vehicle mounted elevated lighting system has been incorporated into a single, integral vehicle light bar assembly which allows both lower and elevated upper light bars of the assembly to illuminate.

### SUMMARY OF THE INVENTION

It is thus the object of the present invention to provide a light bar assembly which overcomes the limitations and disadvantages of previous elevated lighting systems.

It is an object of the present invention to provide a dual light bar assembly which comprises two light bars, each independently operable of the other.

It is another object of the present invention to provide a dual light bar assembly which utilizes two separate light bar components, including a smaller one housed within a cavity of a larger one, with means to elevate the smaller light bar over the larger one.

It is still another object of the present invention to provide a dual light bar assembly to provide visual illumination, and thus enhanced visibility, at greater distances than prior light bars.

It is a further object of the present invention to provide a dual light bar assembly which, when its smaller light bar is not elevated over and is stored within its larger one, results in a compact and streamlined light bar assembly.

These and other objects are accomplished by the present invention, a dual light bar assembly which comprises a base member or first light bar with a cavity inset within the light bar, between its end sections. A smaller, light bar insert panel is configured to be housed within the cavity when only the first light bar is being used. Scissor linkage between the first light bar and the light bar insert panel serves to raise and lower the insert panel from a position within the first light bar to an elevated position over the first light bar, which, as a result of the elevation of the insert panel, provides visual illumination and enhanced visibility at great distances from the vehicle on which the light bar assembly is mounted.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the dual light bar assembly of the present invention with its light bar insert panel housed within its base member.

FIG. 2 is an isometric view of the dual light bar assembly of the present invention with its light bar insert panel extended and elevated above its base member.

FIG. 3 is a partially exploded isometric view of the dual light bar assembly of the present invention in its elevated position.

FIG. 4 is an elevation view of the dual light bar assembly of the present invention in its elevated position.

FIG. 5 is a view of the dual light bar assembly of the present invention mounted on the roof of a vehicle.

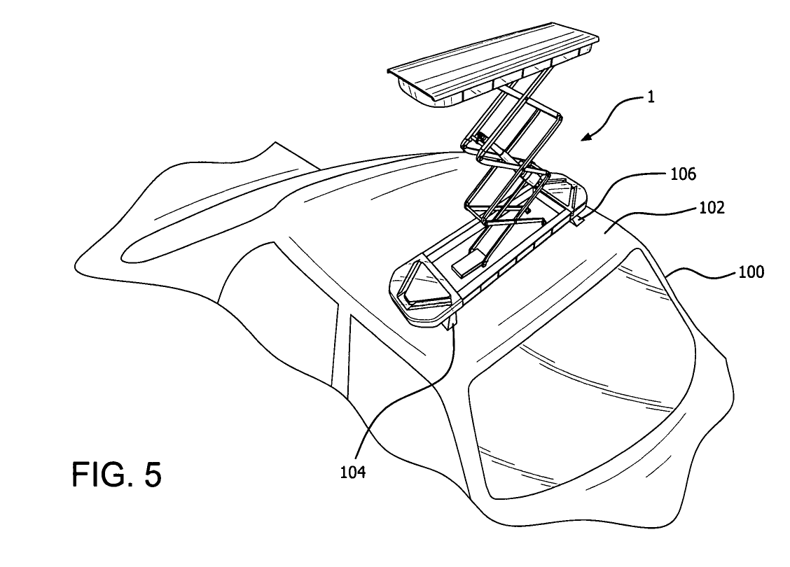

### DETAILED DESCRIPTION OF THE INVENTION

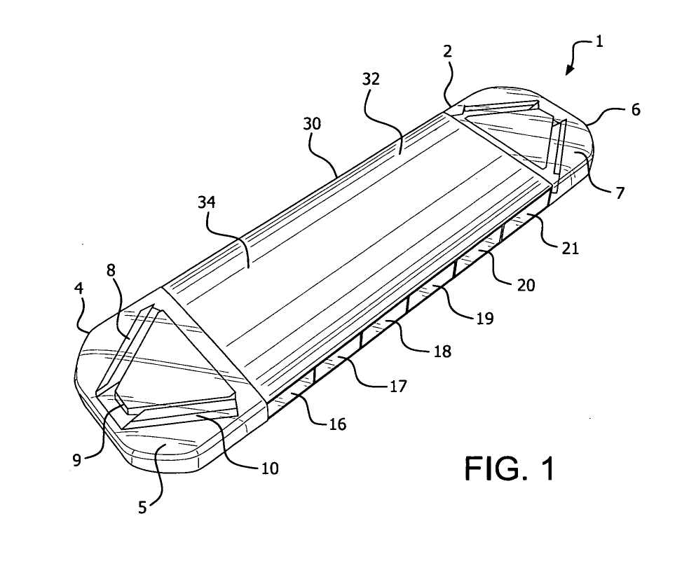

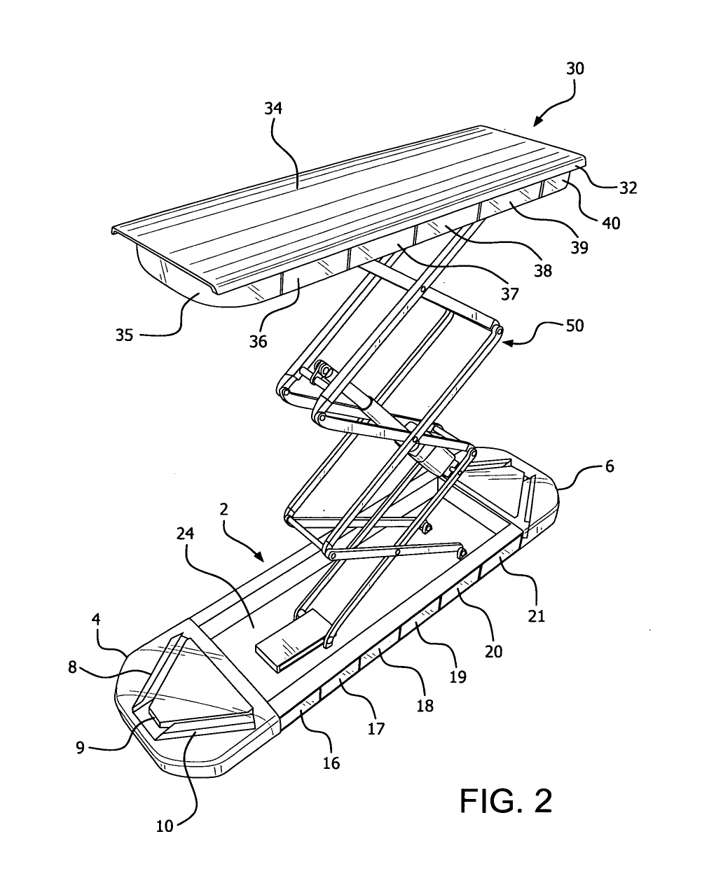

Dual light bar assembly 1 comprises base light bar member or first light bar 2. Light bar 2 has first end section 4 and second end section 6, both end sections having one or more identical, lateral lights and lighting arrays, e.g. 8, 9, and 10, so identified with regard to end section 4 only in FIGS. 1 and 2. Routinely, this lighting is continuous, flashing, intermittent, and/or multi-colored. Lights 16, 17, 18, 19, 20, and 21, shown in the drawings as extending along the front of light bar 2, are similarly located along the back of the light bar as well. This lighting scheme results in 360° illumination around light bar 2. Light bar 2 also comprises cavity 24, which is inset within the light bar, between end sections 4 and 6.

Light bar insert panel 30 comprises top cover member 32 having top surface 34. A plurality of lights 35, 36, 37, 38, 39, and 40, shown in the drawings as extending along the front and one end of light bar panel insert 30, are similarly located around the back and other end of the light bar insert panel. This results in 360° illumination around the light bar insert panel 30. In its lowered position, light bar insert panel 30 rests within cavity 24 of light bar 2, such that its top surface 34 of top cover member 32 resides in substantially the same transverse plane as top surface 5 of first end section 4 and top surface 7 of second end section 6, as best seen in FIG. 1.

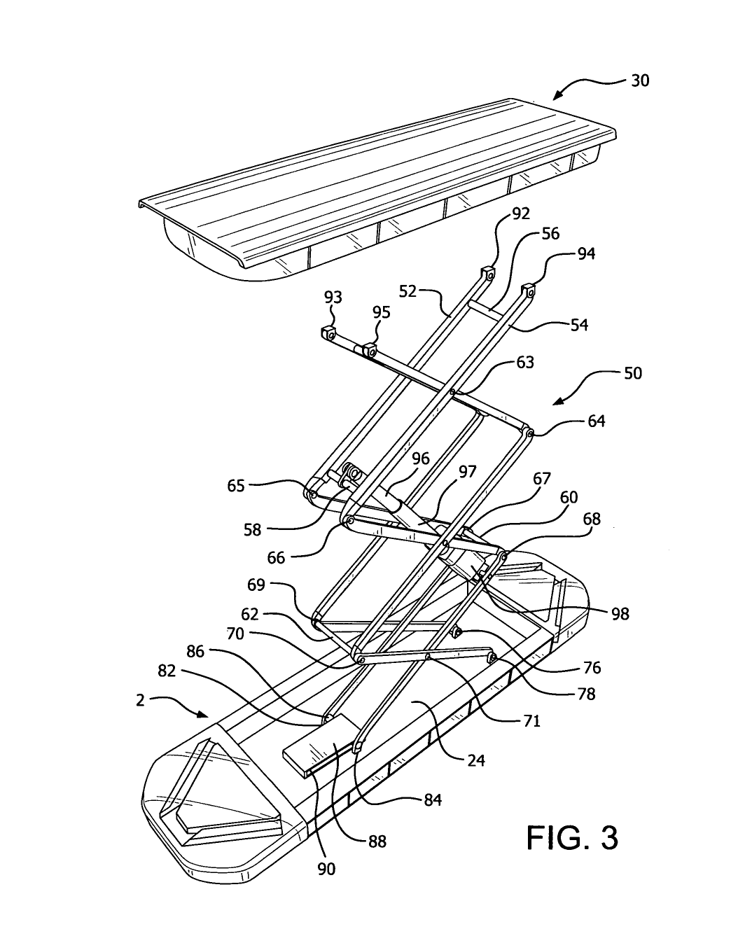

Light bar 2 and light bar insert panel 30 are interconnected by scissors linkage 50. With specific reference to FIG. 3, scissors linkage 50 comprises two lateral arm assembles 52 and 54, interconnected by cross links 56, 58, 60 and 62. Arm assemblies 52 and 54 are made up of a plurality of arm members which are rotatable around pivot connections, e.g. 63, 64, 65, 66, 67, 68, 69, 70, and 71, visible in FIG. 3.

One side of the lower ends of arm assemblies 52 and 54 are rotatable around pivot connections 76 and 78 located within cavity 24 of bar member 2. Opposing lower ends 82 and 84 of arm assemblies 52 and 54 are connected to roller member 86, configured to move fore and aft within roller housing 88 located in cavity 24. Roller member 86 extends and travels through lateral slots located on opposite sides of roller housing 88, only one lateral slot 90 being shown in FIG. 3. Upper ends 92 and 94, and 93 and 95 of arm assemblies 52 and 54 are rotatably connected to the underside of light bar insert panel 30.

Piston 96 is located within piston cylinder 97. Piston 96 is rotatably connected at one end to cross link 58. Cylinder 97 is attached to electric motor 98, which itself is rotatably connected to arm members of arm assemblies 52 and 54. Electrical wiring (not shown in the FIGs.) connects motor 98 to an internal vehicle switch or remote control unit, such electrical systems being well known in the art.

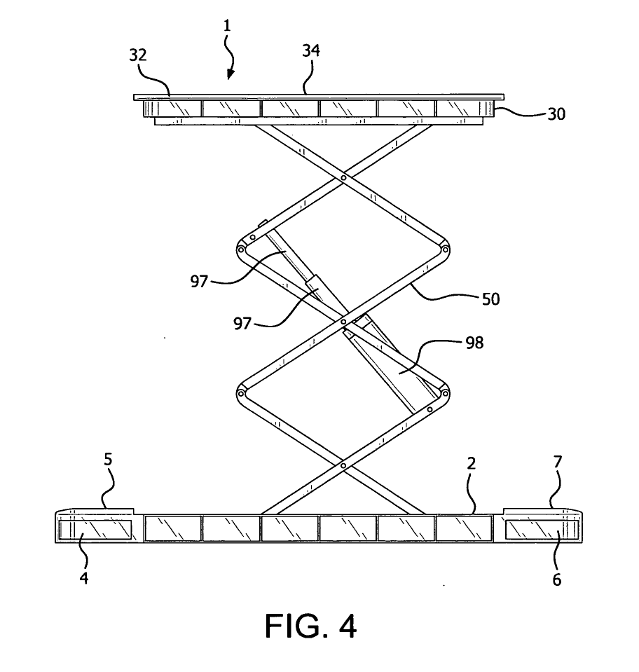

From its lower position within cavity 24, shown in FIG. 1, light bar insert panel 30 is raised to its elevated position, shown in FIGS. 2 and 4, as follows. Actuation of electric motor 98 will cause piston 96 to expand out from cylinder 97, thereby moving lower ends 82 and 84 of arm assemblies 52 and 54 laterally inboard, within cavity 24, via roller member 86, as the roller member travels within lateral slot 90 and its corresponding slot on the opposite side of roller housing 88. As lower ends 82 and 84 more in this direction, arm assemblies 52 and 54 of scissors linkage 50 will be caused to expand, via pivot connections 63-71, and also rotate about upper ends 92 and 94, and 93 and 95, thus lifting light bar insert panel 30 to its elevated position. Light bar insert panel 30 is maintained in this elevated position, until motor 98 is again actuated, causing piston 96 to retreat into its cylinder 97, thereby lowering scissors linkage 50 and light bar insert panel into cavity 24, again positioning top cover member 32 such that it is in the same transverse plane as top surfaces 5 and 7 of light bar 2.

Light bar assembly 1 is configured to be mounted on roof 102 of vehicle 100 by roof supports 99 bolted to the underside of light bar 2 and to the roof

Light bar assembly 1, located atop roof 102 of vehicle 100, will most often be maintained in its lowered position, i.e. when the vehicle is being driven or parked during normal or routine operations. However, when it is necessary to expand the vehicle's circumference of illumination and visual warning, due to accident or other emergent circumstance, motor 98 is turned on, via remote control unit or switch, to actuate piston 96. Scissors linkage 50 will unfold, thus lifting light bar insert panel 30 to its elevated position. When the lights of light bar insert panel 30 are turned on, there is an even distribution of horizontal illumination, well above the vehicle, which provides maximum visibility at far greater distances than would result from the standard, vehicle roof mounted light bar.

While specific lighting configurations for light bar 2 and light bar insert panel 30 are disclosed, it is anticipated that each of these components may be equipped with any array or design of continuous flashing, intermittent, colored lighting which provides effective and particularized visual warning.

It is further contemplated that light bar assembly 1 must be rigidly secured to the roof of vehicles, e.g. by bolted roof mounts 104 and 106, to ensure stability of the assembly when it is in the raised position.

Significantly light bar assembly 1 is only designed to be used with its light bar insert panel 30 in the elevated position, only when the vehicle on which the assembly is mounted is parked and stationary. There are obvious safety considerations to the use of the assembly in the raised position while the vehicle is in motion. As a result, it is anticipated that upon starting the engine of the vehicle, a simple electrical system will be in place which automatically turns on motor 98, thereby actuating piston 96, folding scissors linkage 50, and lowering light bar insert panel 30 into cavity 24 of light bar 2, prior to allowing vehicle movement.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A light bar assembly for attachment to the roof of a vehicle comprising:
a base member having first and second end sections, each section having a top surface, a cavity inset within the base section between the end sections, and a plurality of lights mounted laterally around the base member;
an insert panel sized to fit within the cavity, said panel having a top member with a top surface and a plurality of lights mounted laterally around the panel;
means for vertically raising the insert panel above the base member from a first position, in which the insert panel is resting within the cavity of the base member with the top surface of its top member in substantially the same transverse plane as the top surface of the first and second end sections of the base member, to a second position in which the insert panel is maintained and fixed in an elevated position over the base member; and
means to mount the base member onto the roof of a vehicle.

2. The light bar assembly as in claim 1 wherein the means for vertically raising the insert panel is configured to lower the panel from the second position in which the inset panel is elevated over the base member, to the first position, in which the insert panel is resting within the cavity of the base member with the top surface of its top member in substantially the same transverse plane as the top surfaces of the first and second end sections of the base member.

3. The light bar assembly as in claim 1 wherein the means for raising comprises a motor operated piston and a pivotable scissors connection, said piston configured to raise and lower the scissors connection, thereby raising and lowering the insert panel.

4. A dual light bar assembly for attachment to the roof of a vehicle comprising:
a first light bar having a first end section comprising at least one light and a second end section comprising at least one light, each section having a top surface, a cavity inset within the light bar between the end sections, and a plurality of lights laterally mounted along the sides of the light bar;
a second light bar sized to fit within the cavity of the first light bar, the second light bar having a top member with a top surface and a plurality of lights laterally mounted around the second light bar;
means for vertically raising the second light bar above the first light bar from a first position, in which the second light bar is resting within the cavity of the first light bar with the top surface of its top member in substantially the same transverse plane as the top surface of the first and second end sections of the first light bar, to a second position in which the second light bar is maintained and fixed in an elevated position over the first light bar; and
means to mount the first light bar onto the roof of a vehicle.

5. The dual light bar assembly as in claim 4 wherein the means for vertically raising the second light bar is configured to lower said light bar from the second position in which the second light bar is elevated over the first light bar, to the first position, in which the second light bar is resting within the cavity of the first light bar with the top surface of its top member in substantially the same transverse plane as the top surfaces of the first and second end sections of the first light bar.

6. The dual light bar assembly as in claim 4 wherein the means for raising comprises a motor operated piston and a pivotable scissors connection, said piston configured to raise and lower the scissors connection, thereby raising and lowering the second light bar.
